(19) United States
(12) Patent Application Publication
(10) Pub. No.: US 2012/0211118 A1
(43) Pub. Date: Aug. 23, 2012

(54) MULTILAYER TUBE FOR HYDRAULIC CONNECTION AND WIRING OF SOLAR PANELS

(75) Inventor: Francesco Tognon, Padova (IT)

(73) Assignee: Everlux S.R.L., Padova (IT)

(21) Appl. No.: 13/504,445

(22) PCT Filed: Oct. 26, 2010
(86) PCT No.: PCT/EP10/66124

§ 371 Date: Apr. 26, 2012

(30) Foreign Application Priority Data
Oct. 28, 2009 (IT) PD2009A000316

(51) Int. Cl. F16L 9/14

(52) U.S. Cl. 138/149

(57) ABSTRACT

A multilayer tube for the hydraulic connection and wiring of solar panels, which comprises at least two tubes, one for delivery and one for return, for a heat transfer fluid designed to circulate in at least one solar panel with which the multilayer tube is associated, the tubes being extended along parallel paths, at least one thermal insulation layer based on Aerogel, arranged so as to wrap around each tube, a protection and containment sheath, which is arranged so as to surround all of the tubes with an insulating layer made of Aerogel, the sheath being contoured so as to form a longitudinal containment channel for at least one electrical wiring cable.

### TECHNICAL FIELD

The present invention relates to a multilayer tube for hydraulic connection and wiring of solar panels.

### BACKGROUND ART

Currently, in order to install a solar panel of the thermal type, i.e., dedicated to the heating of water intended for example for a home, one proceeds, after laying the panels, with the provision of the hydraulic and electrical connections.

The one or more fitted solar panels must be reached by a supply duct for the water to be heated and by a return duct for such water heated by passing through the one or more panels and, in the case for example of solar power systems with forced circulation, by an electrical connection for a probe for detecting the temperature of the water at the panel manifolds.

Such a complex installation is costly both in terms of time, since each duct and the wiring cable each require a dedicated path with a dedicated seat or chase or in any case must be laid each independently of the other, and in terms of space occupation, since according to currently applicable statutory provisions each duct for heat transfer fluids must be insulated thermally with layers of insulation which, in order to ensure the required performance, cause the individual duct to produce a diametrical space occupation of more than six centimeters.

### DISCLOSURE OF THE INVENTION

The aim of the present invention is to provide a multilayer tube for hydraulic connection and wiring of solar panels by means of which it is possible to connect hydraulically one or more solar panels quickly and with an extremely small space occupation that is far lower than the space occupation required by known means.

Within this aim, an object of the invention is to provide a multilayer tube compliant with applicable statutory provisions and whose performance and efficiency are not inferior to those of currently known thermally insulated tubes.

Another object of the invention is to provide a multilayer tube that can be curved with bending radiuses that are not disadvantageous with respect to the minimum radiuses that can be obtained with known thermally insulated tubes.

Another object of the invention is to propose a multilayer tube that is structurally simple and easy to use and can be manufactured at low costs.

This aim, as well as these and other objects that will become better apparent hereinafter, are achieved by a multilayer tube for hydraulic connection and wiring of solar panels, characterized in that it comprises
at least two tubes, one for delivery and one for return, for a heat transfer fluid designed to circulate in at least one solar panel with which the multilayer tube is associated, said tubes being extended along parallel paths,
at least one thermal insulation layer based on Aerogel, arranged so as to wrap around each tube,
a protection and containment sheath, which is arranged so as to surround all of said tubes with an insulating layer made of Aerogel, said sheath being contoured so as to form a longitudinal containment channel for at least one electrical wiring cable.

### BRIEF DESCRIPTION OF THE DRAWINGS

Further characteristics and advantages of the invention will become better apparent from the following detailed description of a preferred but not exclusive embodiment of the multilayer tube according to the invention, illustrated by way of non-limiting example in the accompanying drawings, wherein:

FIG. 1 is a perspective view of a portion of a multilayer tube according to the invention;

FIG. 2 is a schematic view of an application of the multilayer tube according to the invention.

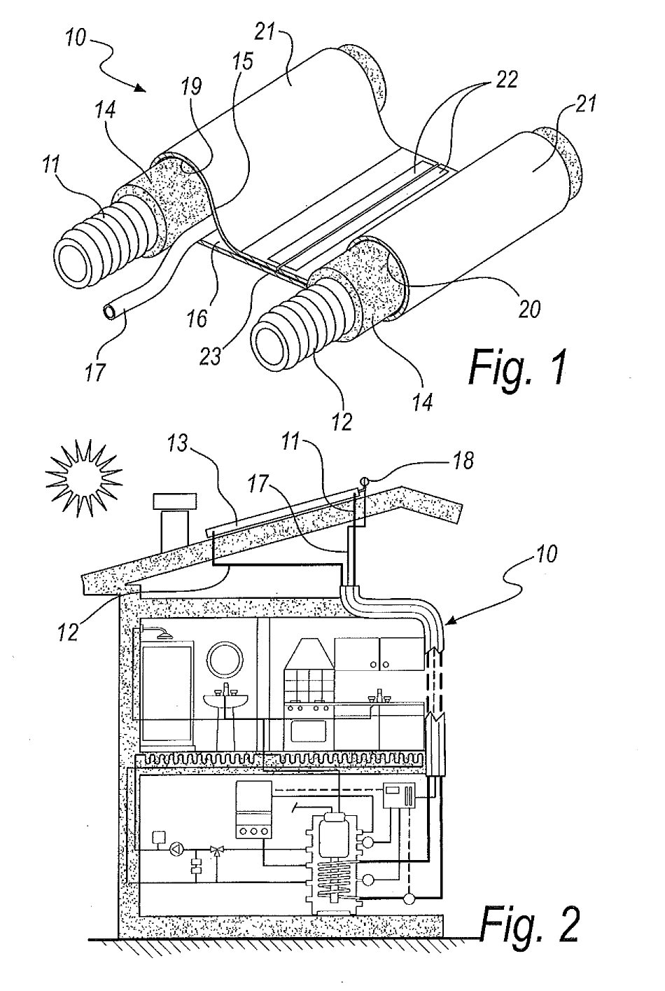

### WAYS OF CARRYING OUT THE INVENTION

With reference to the figures, a multilayer tube for the hydraulic connection and wiring of solar panels is generally designated by the reference numeral 10.

The multilayer tube 10 comprises, in the embodiment described here by way of non-limiting example of the invention,
two tubes, a delivery tube 11 and a return tube 12, for a heat transfer fluid designed to circulate in at least one solar panel 13 with which the multilayer tube 10 is associated; the tubes 11 and 12 are substantially parallel, i.e., run along parallel paths;
a thermal insulating layer 14 based on Aerogel, arranged so as to wrap around each one of the tubes 11 and 12,
a protection and containment sheath 15, which is arranged so as to surround both of the tubes 11 and 12 with the insulating layer 14 made of

Aerogel; the sheath 15 is contoured so as to form a longitudinal containment channel 16 for at least one electrical wiring cable 17, for example for a temperature probe 18 associated with the solar panel 13.

The multilayer tube 10 according to the invention can be wound in a spool and can be palletized easily and cheaply with an advantageous reduction of packaging bulk.

The multilayer tube 10 can be provided with the two tubes 11 and 12 that have a center distance comprised between 5 and 20 centimeters according to the requirements and needs.

The tubes 11 and 12 are made of steel, preferably of the corrugated type, but not exclusively.

The tubes 11 and 12 have an average cross-section with a diameter comprised between 1.5 and 4 centimeters, in this case also according to the requirements and particularities in application.

The insulating layer 14 made of Aerogel has a thickness comprised between 0.3 centimeters and 2 centimeters.

These dimensions reduce considerably the overall space occupation of each tube with insulating layer with respect to known thermally insulated tubes.

The protection and containment sheath 15 is made of coated fabric, with normal or braided pull-resistant warp.

The sheath 15 is contoured so as to form two lateral tubular channels 19 and 20, one for each one of the tubes 11 and 12 wrapped in the insulating layer 14.

Each channel 19 and 20 is constituted by the folding of a flap 21 so as to surround a corresponding tube, the edge 22 of the flap being fixed to a central region 23 of such sheath by adhesive bonding or by high-frequency welding or by means of other similar and equivalent methods.

In a further embodiment of the multilayer tube according to the invention, the sheath 15 is constituted by a sheet made of metallic material, whose flaps are folded so as to surround a corresponding tube, the edge of such flap being fixed to a central region of such sheath by spot welding.

In practice it has been found that the invention achieves the intended aim and objects.

In particular, the invention provides a multilayer tube for hydraulic connection and wiring of solar panels by means of which it is possible to connect hydraulically one or more solar panels quickly and with extremely reduced space occupations, far smaller than the space occupations imposed by known means.

Further, the invention provides a multilayer tube that is compliant with applicable statutory provisions and whose performance and efficiency are not inferior to those of currently known thermally insulated tubes.

Moreover, the invention provides a multilayer tube that can be curved with bending radiuses that are not disadvantageous with respect to the minimum radiuses that can be obtained with known thermally insulated tubes,

Not least, the invention has proposed a multilayer tube that is structurally simple and easy to use and can be manufactured at low costs.

The invention thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. PD2009A000316 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-8. (canceled)

9. A multilayer tube for the hydraulic connection and wiring of solar panels, comprising
at least two tubes, one for delivery and one for return, for a heat transfer fluid designed to circulate in at least one solar panel with which the multilayer tube is associated, said tubes being extended along parallel paths,
at least one thermal insulation layer based on Aerogel, arranged so as to wrap around each tube,
a protection and containment sheath, which is arranged so as to surround all of said tubes with an insulating layer made of Aerogel, said sheath being contoured so as to form a longitudinal containment channel for at least one electrical wiring cable.

10. The multilayer tube according to claim 9, wherein it can be wound in a coil.

11. The multilayer tube according to claim 9, wherein said two tubes have a center distance comprised between 5 and 20 centimeters.

12. The multilayer tube according to claim 9, wherein said tubes are made of steel, of the corrugated type, with an average cross-section whose diameter is comprised between 1.5 and 4 centimeters.

13. The multilayer tube according to claim 9, wherein said insulating layer made of Aerogel has a thickness comprised between 0.3 centimeters and 2 centimeters.

14. The multilayer tube according to claim 9, wherein said protection and containment sheath is made of coated fabric, with normal or braided pull-resistant warp.

15. The multilayer tube according to claim 9, wherein said sheath is contoured so as to form two lateral tubular channels, one for each one of the tubes wrapped in an insulating layer, each channel being constituted by the folding of a flap so as to surround a corresponding tube, an edge of said flap being fixed to a central region of said sheath by adhesive bonding or by high-frequency welding or by means of other similar and equivalent methods.

16. The multilayer tube according to claim 9, wherein said sheath is constituted by a sheet made of metallic material, whose flaps are folded so as to surround a corresponding tube, an edge of said flap being fixed to a central region of said sheath by spot welding.
